(19) United States
(12) Patent Application Publication
(10) Pub. No.: US 2006/0286443 A1
(43) Pub. Date: Dec. 21, 2006

(54) Battery seat with a battery holder

(76) Inventor: Huang-Chou Huang, Taipei Hsien (TW)

Correspondence Address: HERSHKOVITZ & ASSOCIATES, 2845 DUKE STREET, ALEXANDRIA, VA, 22314, US

(21) Appl. No.: 11/156,655

(22) Filed: Jun. 21, 2005

(51) Int. Cl. H01M 2/10

(52) U.S. Cl. 429/100

(57) ABSTRACT

A battery seat has a base and a battery holder. The base has a cavity, a sidewall, two terminal seats, multiple mounting holes and two terminals. The cavity is defined in the battery seat and holds a disk battery. The sidewall extends up from the base around the cavity. The mounting holes are defined through the sidewall and communicate with the cavity. The battery holder is mounted detachably in the cavity of the base, securely holds the disk battery in the cavity and has two ends, two compression tabs and multiple protrusions. The compression tabs are formed respectively on the ends and extend up. The protrusions are formed on the battery holder, correspond to and are mounted detachably through the through holes in the sidewall of the base. The battery holder presses against the disk battery and prevents the disk battery from dislodging from the cavity.

### BACKGROUND OF THE INVENTION

1. Field of the Invention

The present invention relates to a battery seat, and more particularly to a battery seat with a battery holder that securely holds a disk battery.

2. Description of Related Art

Disk batteries are used widely in daily life. Lots of miniature devices such as “credit card” calculators have a battery seat to hold a disk battery.

With reference to FIG. 5, a conventional battery seat (40) is mounted in an electrical device, holds a disk battery (50) with an outer edge, a positive terminal and a negative terminal and has an outer edge, a cavity (41), multiple rigid battery hooks, a positive terminal (42), a negative terminal (43).

The cavity (41) is defined in the battery seat (40) and holds the disk battery (50).

The rigid battery hooks extend perpendicularly up from the outer edge of the battery seat (40) and hook the outer edge of the disk battery (50).

The positive terminal (42) is mounted on the battery seat (40) opposite to the rigid battery hooks, makes contact with the positive terminal of the disk battery (50) in the cavity (41) and has a resilient battery hook (421). The resilient battery hook (421) is formed on the positive terminal (42), hooks the outer edge of the disk battery (50) and, in conjunction with the rigid battery hooks, holds the disk battery (50) in the cavity (41).

The negative terminal (43) is mounted in the cavity (41), makes contact with the negative terminal of the disk battery (50) and extends out of the battery seat (40) opposite to the positive terminal (42).

However, the disk battery (50) easily dislodges from the battery seat (40) when an inadvertent external force impacts an electrical device in which the battery seat (40) is mounted because the resilient hook (421) tends to lose its resiliency over time.

To overcome the shortcomings, the present invention provides a battery seat with a battery holder to mitigate or obviate the aforementioned problems.

### SUMMARY OF THE INVENTION

The main objective of the invention is to provide a battery seat with a battery holder that securely holds a disk battery.

A battery seat in accordance with the present invention comprises a base and a battery holder.

The base has a cavity, a sidewall, two terminal seats, multiple mounting holes and two terminals. The cavity is defined in the battery seat and holds a disk battery. The sidewall extends up from the base around the cavity. The mounting holes are defined through the sidewall and communicate with the cavity.

The battery holder is mounted detachably in the cavity of the base, securely holds the disk battery in the cavity and has two ends, two compression tabs and multiple protrusions. The compression tabs are formed respectively on the ends and extend up. The protrusions are formed on the battery holder, correspond to and are mounted detachably through the through holes in the sidewall of the base.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a battery seat in accordance with the present invention with a disk battery;

FIG. 2 is an exploded perspective view of the battery seat in FIG. 1;

FIG. 3 is top view of the battery seat in FIG. 1;

FIG. 4 is a cross sectional side view of the battery seat in FIG. 1; and

FIG. 5 is a perspective view of a conventional battery seat in accordance with the prior art with a disk battery.

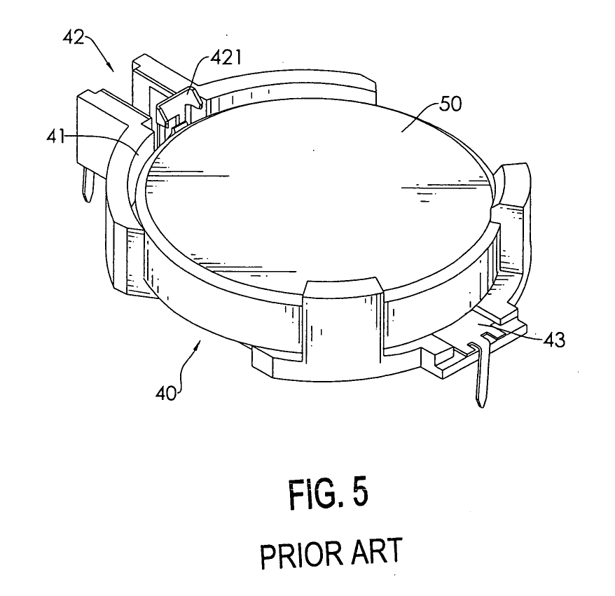

### DETAILED DESCRIPTION OF PREFERRED EMBODIMENT

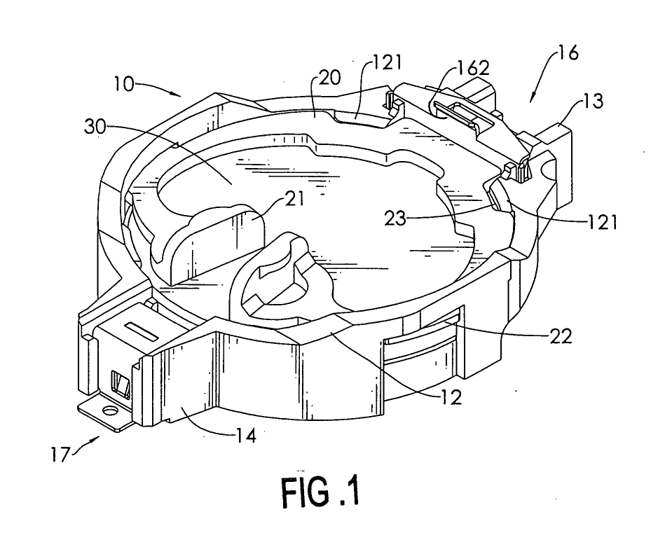

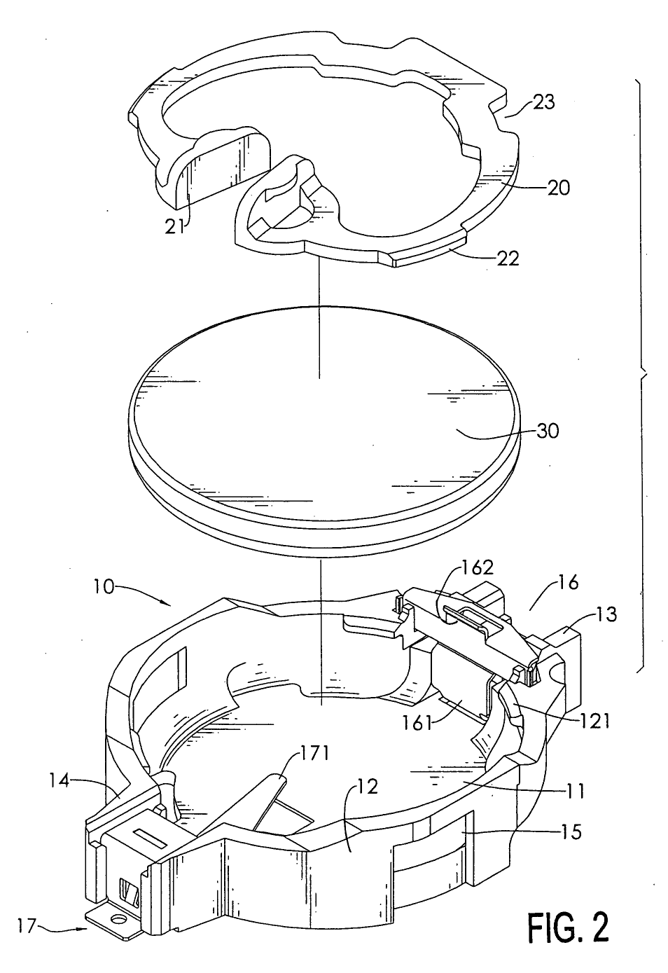

With reference to FIGS. 1 and 2, a battery seat in accordance with the present invention holds a disk battery (30). The disk battery has a top, an outer edge, a positive terminal and a negative terminal (not shown).

The battery seat comprises a base (10) and a battery holder (20).

The base (10) has a bottom, a cavity (11), a sidewall (12), a positive terminal seat (13), a negative terminal seat (14), multiple mounting holes (15), a positive terminal (16) and a negative terminal (17).

The cavity (11) is defined in the base (10) and holds a disk battery (30).

The sidewall (12) extends up from the bottom around the cavity (11) and has an inside surface and two pairs of optional lips (121). The pairs of lips (121) are formed separately on the inside surface of the sidewall (12) opposite to each other and extend radially inward to hold the disk battery (30) in the cavity (11).

The positive terminal seat (13) is formed in the sidewall (12) between one pair of lips (121).

The negative terminal seat (14) is formed in the sidewall (12) between the other pair of lips (121) opposite to the positive terminal seat (13).

The mounting holes (15) are defined through the sidewall (12) and communicate with the cavity (11).

The positive terminal (16) is mounted in the positive terminal seat (13) on the base (10) and has a positive contact (161) and an optional tab (162). The positive contact (161) is resilient, is formed on the positive terminal (16), extends into the cavity (11), presses against the positive terminal of the disk battery (30) and has a top end. The tab (162) is connected to the top end of the positive contact (161). Pressing the tab (162) allows the disk battery (30) to be removed from the cavity (11).

The negative terminal (17) is mounted in the negative terminal seat (14) on the base (10) and has a negative contact (171). The negative contact (171) is resilient, is formed on the negative terminal (17), extends obliquely up into the cavity (11) and presses against the negative terminal of the disk battery (30).

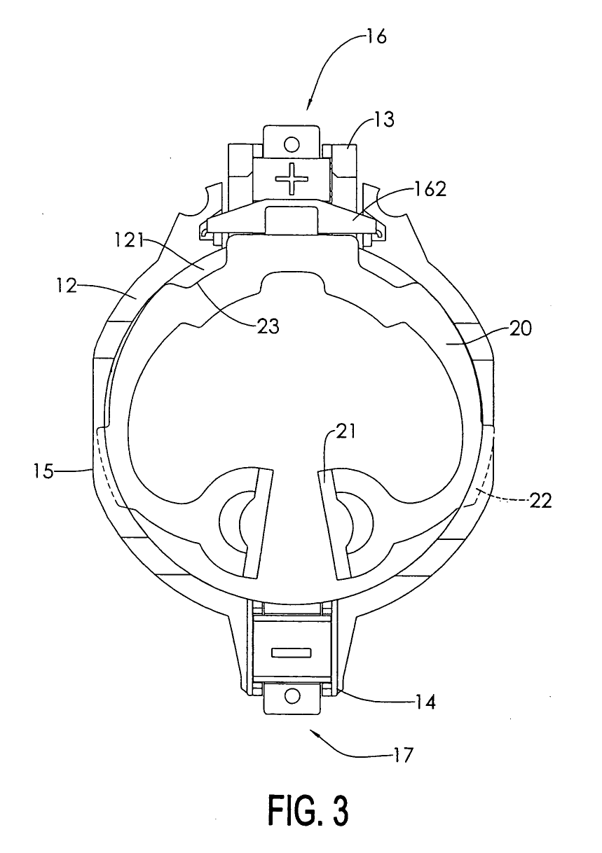

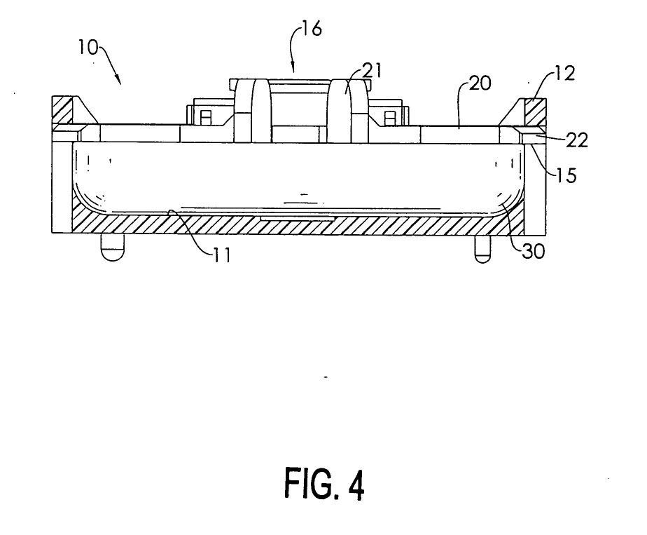

With further reference to FIGS. 3 and 4, the battery holder (20) is a resilient C-shaped ring, is mounted detachably in the cavity (11) of the base (10) and presses against the top of the disk battery (30) to prevent the disk battery (30) from falling out of the cavity (11). The battery holder (20) has two ends, an outer edge, an inner diameter, a gap, two compression tabs (21), multiple protrusions (22) and two pairs of optional recess (23). The gap is defined between the ends. The compression tabs (21) are formed respectively on the ends. Squeezing the compression tabs (21) together reduces the inner diameter and allows the battery holder (20) to be installed in the cavity (11) of the base (10). The protrusions (22) are formed on the outer edge of the battery holder (20), correspond to and are detachably mounted respectively through the through holes (15) in the sidewall (12) of the base (10). The pairs of the recesses (23) are defined separately in the outer edge of the battery holder (20), correspond to and align respectively with the lips (121).

Because the battery holder (20) is securely mounted in the base (10), the disk battery (30) will not dislodge from the cavity (11) when an inadvertent external force impacts the battery seat.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A battery seat comprising:
a base having
a bottom;
a cavity defined in the base;
a sidewall extending up from the bottom around the cavity and having an inside surface;
a positive terminal seat formed in the sidewall;
a negative terminal seat formed in the sidewall;
multiple mounting holes defined through the sidewall and communicating with the cavity;
a positive terminal mounted in the positive terminal seat on the base and having a positive contact being resilient, formed on the positive terminal, extending into the cavity and having a top end; and
a negative terminal mounted in the negative terminal seat on the base and having a resilient negative contact formed on the negative terminal and extending into the cavity; and
a battery holder mounted detachably in the cavity of the base, being a resilient C-shaped ring and having
two ends;
an outer edge;
a gap defined between the ends;
two compression tabs formed respectively on the ends; and
multiple protrusions formed on the outer edge of the battery holder, corresponding to and detachably mounted respectively through the through holes in the sidewall of the base.

2. The battery seat as claimed in claim 1, wherein:
the sidewall of the base further has two pairs of lips formed separately on the inside surface of the sidewall opposite to each other and extending radially inward;
the positive terminal seat is formed between one pair of lips;
the negative terminal seat is formed between the other pair of lips; and
the battery holder further has two pairs of recesses defined separately in the outer edge of the battery holder, corresponding to and aligning respectively with the pairs of lips.

3. The battery seat as claimed in claim 1, wherein the positive terminal further has a tab connected to the top end of the positive contact.
